(19) United States
(12) Patent Application Publication
(10) Pub. No.: US 2020/0099038 A1
(43) Pub. Date: Mar. 26, 2020

(54) METHOD AND SYSTEM FOR PRODUCING A BATTERY CELL

(71) Applicant: Robert Bosch GmbH, Stuttgart (DE)

(72) Inventors: Michael Butzin, Friolzheim (DE); Patrick Reimann, Bamberg (DE)

(21) Appl. No.: 16/470,304

(22) PCT Filed: Nov. 14, 2017
(86) PCT No.: PCT/EP2017/079145

§ 371 Date: Jun. 17, 2019

(30) Foreign Application Priority Data
Dec. 15, 2016 (DE) 10 2016 225 173.2

(51) Int. Cl. H01M 2/36; H01M 10/04

(52) U.S. Cl. CPC H01M 2/362; H01M 10/0404

(57) ABSTRACT

The invention relates to a method and a system for producing a battery cell (1), wherein the battery cell (1) has an electrode arrangement (3) and a housing (2) which comprises an opening (6). The method comprises the following chronologically successive method steps: wherein the battery cell (1) is filled with an electrolyte (7) via the opening, and wherein, in a first rotation step, the battery cell (1) is rotated, in particular by more than 360°, about a rotational axis (12).

### BACKGROUND OF THE INVENTION

The present invention relates to a method and to a system for producing a battery cell.

US 2013/0065111 A1 discloses a device and a method for the improved distribution of electrolyte in a secondary battery. In this case, the secondary battery is oscillated and rotated about the centerline thereof.

US 2013/0244095 A1 discloses a degassing method for a secondary battery by means of centrifugal force.

Battery systems are used both in stationary applications, such as wind turbines or solar energy systems, and in motor vehicles, such as hybrid vehicles or electric vehicles, or in electronic devices, such as laptops or mobile telephones.

### SUMMARY OF THE INVENTION

The invention proceeds from a method for producing a battery cell, wherein the battery cell has an electrode arrangement and a housing which has an opening,
comprising the chronologically successive method steps:
wherein the battery cell is filled with an electrolyte by means of the opening,
wherein in a first rotation step, the battery cell is rotated about an axis of rotation, in particular is rotated by more than 360°.

The core of the invention consists in the fact that the electrolyte is introduced into the housing and, to wet the electrode arrangement with the electrolyte, the battery cell is rotated.

The background of the invention is that, as a result of the rotation, a centrifugal force acts on the electrolyte. This centrifugal force pushes the electrolyte to a base portion of the housing. Capillary forces cause the electrolyte to penetrate and wet the electrode arrangement.

The invention thus provides improved wetting of the electrode arrangement with electrolyte by comparison with a battery cell which is not rotated.

In this case, advantageously no pressure which could deform the housing is exerted on the housing. As a result, the housing can have a thinner and lighter design than in the case of a battery cell into which the electrolyte is introduced by means of pressure.

The dependent claims relate to further advantageous embodiments of the present invention.

According to one advantageous embodiment, in a second rotation step, by contrast with the method step of filling with electrolyte, the battery cell is rotated by 160° to 200°, in particular 180°, and subsequently mounted. In this case, it is advantageous that, as a result of the gravitational force, which acts in the opposite direction to during the filling, the electrolyte flows in the opposite direction to during the filling. During the mounting, capillary forces act on the electrolyte which bring about a penetration of the electrolyte into the electrode arrangement and the wetting of said arrangement with electrolyte in a region of the electrode arrangement which is adjacent to the opening.

Advantageously, during the mounting, the electrolyte flows in the gravitational direction to the opening. Thus, a wetted region of the electrode arrangement is enlarged, since the electrolyte flows in the opposite direction to during the filling.

Furthermore, it is advantageous when, before the second rotation step, the opening in the housing is closed in a liquid-tight manner by a closure means, in particular a plug or a metal strip, in particular in a removable manner. In this manner, the electrolyte is prevented from spraying out of the housing during the second rotation step and/or from flowing out of the housing during the mounting.

Preferably, after the mounting, the closure means is removed from the housing, and excess electrolyte is released from the battery cell. The excess electrolyte can be reused to produce another battery cell.

Furthermore, it is advantageous when the battery cell is subsequently sealed, in particular by means of a pressure relief valve. As a result thereof, the pressure relief valve is connected to the battery cell only after the rotation steps. It is thus possible to prevent the pressure relief valve from being inadvertently released during one of the rotation steps. In addition, during the initial operation, the pressure relief valve has no preexisting defects as a result of the process of producing the battery cell.

Advantageously, before the second rotation step, additional electrolyte is filled into the battery cell. Targeted dosing of the electrolyte during the method is thus made possible. The amount of excess electrolyte can be reduced.

Furthermore, it is advantageous when, in the first rotation step, the opening is unsealed. As a result of this, a pressure equalization inside the housing during the first rotation step is made possible. Gases produced during the activation of the battery cell can escape through the opening so that an explosion of the battery cell can be prevented. As a result, the battery can have a compact design, since no additional space has to be provided in the housing for these gases. An additional process step for opening and degassing the battery cell can be omitted.

According to the invention, during the filling of the battery cell, the electrolyte flows from the opening in the gravitation direction into the housing. In this case, it is advantageous that the electrolyte flows into the housing at normal pressure. The pressure load of the housing of the battery cell is thus low. The housing can have a compact and light design.

Preferably, the axis of rotation is at a distance from the battery cell. In this case, a retaining means can be arranged between the battery cell and a shaft rotating about the axis of rotation to connect the battery cell to the shaft. Advantageously, a plurality of battery cells can be rotated about the axis of rotation at the same time.

Furthermore, it is advantageous when a surface of the housing having the opening is at the shortest distance of the housing from the axis of rotation. In this case, the opening is advantageously arranged at the center of rotation of the battery cell, and therefore the electrolyte is moved away from the opening by means of the centrifugal force. It is thus possible to prevent electrolyte from leaking out of the battery cell.

Preferably, the surface is in contact with the axis of rotation at least in part. The electrolyte is thus moved away from the opening by means of the centrifugal force. It is possible to prevent electrolyte from leaking out of the battery cell.

Furthermore, it is advantageous when the axis of rotation is oriented transversely to the gravitational direction. Thus, during the first rotation step, the battery cell performs a somersault about the lateral axis thereof. The gravitational force temporarily acts in the same direction as the centrifugal force, and therefore the gravitational force and the centrifugal force temporarily strengthen one another.

According to another advantageous embodiment, during the first rotation step, the battery cell is deflected in a transverse direction to the axis of rotation. Advantageously, the battery cell is pivotally connected to a shaft rotating about the axis of rotation. When the axis of rotation is oriented parallel to the gravitational direction, the centrifugal force acts transversely to the gravitational direction and deflects the battery cell. Advantageously, the battery cell is pivotally connected to the shaft in the region of the opening, and therefore the battery cell is substantially deflected about the opening.

The invention proceeds from a system for producing a battery cell, in particular by means of a method as described previously or according to any of the claims related to the method.

The core of the invention consists in the fact that the system comprises a battery cell and a retaining means, the battery cell being able to be connected by the retaining means to a rotatably mounted shaft of a rotating motor.

The background of the invention is the fact that the battery cell can be detachably connected in a simple manner to the rotatably mounted shaft.

According to the invention, by means of a rotation, in particular by more than 360°, an electrolyte arranged in the battery cell can be distributed uniformly in an electrode arrangement of the battery cell.

The dependent claims relate to further advantageous embodiments of the present invention.

Furthermore, it is advantageous when the battery cell comprises a housing having a peripheral groove, the retaining means having a recess, the housing and the retaining means being able to be connected by means of the groove and the recess. Advantageously, the housing and the retaining means can be interconnected in an interlocking manner.

Preferably, the groove has a stepped design, the housing tapering in a stepped manner towards one lateral face of the housing, the retaining means having a cavity in which at least part of the battery cell is received. In this case, it is advantageous that the retaining means retains and protects the battery, since the retaining means surrounds the battery cell at least in part.

Advantageously, the recess and the groove have the same cross section. The retaining means and the housing can thus be interconnected in a plug-in manner, in that an end region of the housing which is tapered in a stepped manner is plugged into the recess in the retaining means.

According to another advantageous embodiment, the housing has a peripheral protrusion, the retaining means being able to be clipped to the housing by means of the protrusion, the retaining means being elastically deformable. In this case, it is advantageous that the retaining means is elastically deformable in the transverse direction to the centrifugal force occurring during a rotation. The housing can thus be connected to the retaining means in a secure and detachable manner.

### BRIEF DESCRIPTION OF THE DRAWINGS

In the following section, the invention will be explained on the basis of exemplary embodiments which can provide additional features of the invention, but to which the scope of the invention is not limited. The exemplary embodiments are shown in the drawings, in which:

FIG. 1 is a schematic view of a battery cell 1 in a first method step of a method according to the invention;

FIG. 2 is a schematic view of the battery cell 1 in a second method step of the method according to the invention;

FIG. 3 is a schematic view of the battery cell 1 in a third method step of the method according to the invention;

FIG. 4 shows a first embodiment of a battery cell 31;

FIG. 5 shows the first embodiment of the battery cell 31 which is related to a first embodiment of a retaining means 40,

FIG. 6 shows a second embodiment of a battery cell 51; and

FIG. 7 shows the second embodiment of the battery cell 51 which is related to a second embodiment of a retaining means 60.

### DETAILED DESCRIPTION

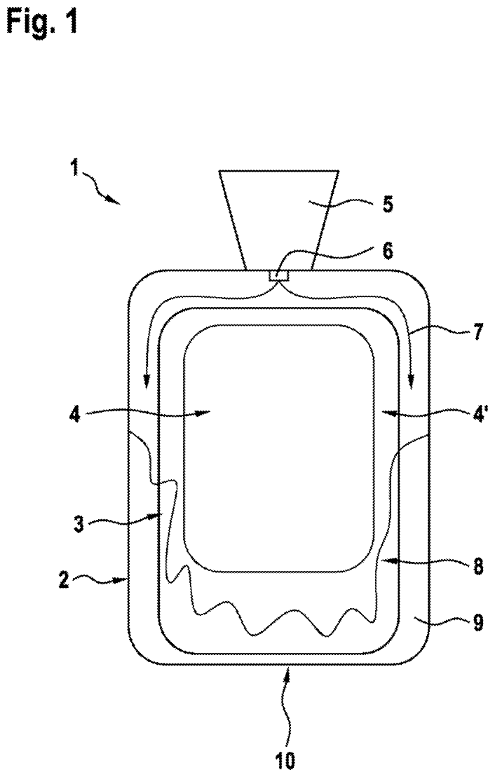

FIG. 1 is a sectional view of the battery cell 1. The battery cell 1 comprises a housing 2 and an electrode arrangement 3. The electrode arrangement 3 is arranged inside the housing 2. In this case, the electrode arrangement 3 is arranged at a distance from the housing 2 at least in part, and therefore a first spatial region 9 is arranged between the housing 2 and the electrode arrangement 3. Preferably, the first spatial region 9 completely surrounds the electrode arrangement 3.

In this case, a battery cell is understood to mean for example a rechargeable cell of a rechargeable battery, in particular an electrochemical battery cell. The battery cell can be in the form of a lithium-based battery cell, in particular a lithium-ion battery cell. Alternatively, the battery cell is in the form of a lithium-polymer battery cell or a nickel-metal hydride battery cell or a lead-acid battery cell or a lithium-air battery cell or a lithium-sulfur battery cell.

The housing 2 has an opening 6. The opening 6 of the housing 2 can be connected to a valve 5 of an electrolyte tank. The housing 2 can thus be filled with an electrolyte 7 by means of the opening 6 and the valve 5.

In a first method step of the method according to the invention, the battery cell 1 is arranged in the gravitational direction in such a way that the opening 6 of the housing 2 is arranged at the highest point of the housing 2. An electrolyte 7, which is poured in through the opening 6 in the first method step, thus flows in the gravitational direction into the housing 2. In this case, the electrolyte 7 flows along the first spatial region 9 and wets a first portion 4′ of the electrode arrangement 3 which is adjacent to the first spatial region 9. The electrolyte 7 collects on a base portion 10 of the housing 2, the base portion 10 being the portion of the housing 2 which is at the greatest distance from the opening 6 in the gravitational direction. In this case, a fill level 8 of the electrolyte 7 is at the highest at the wall of the housing 2 and decreases towards the center of the housing 2. As a result, the electrode arrangement 3 has a second portion 4 which is wetted with less electrolyte 7 than the first portion 4′. In the first method step, the second portion 4 is at a greater distance from the base portion 10 of the housing 2 than from the opening 6.

In this case, gravitational direction is understood to mean the direction in which the gravitational force acts.

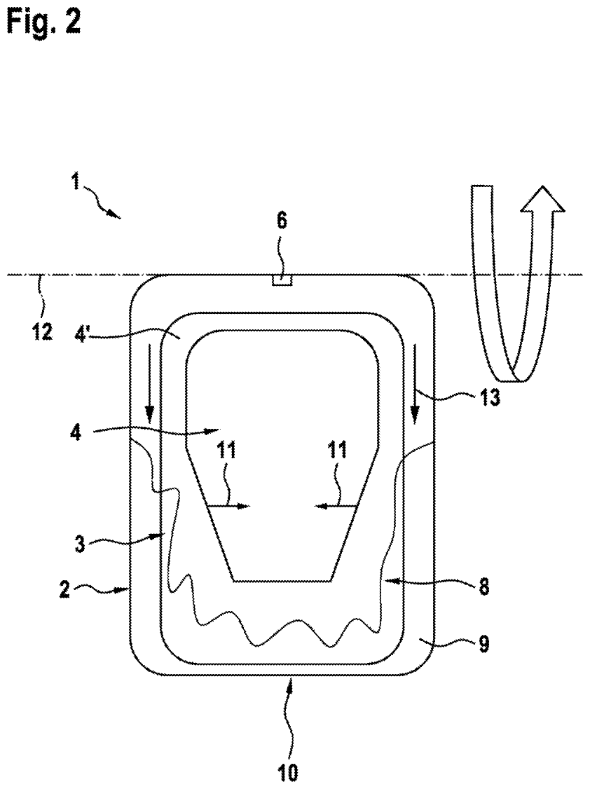

FIG. 2 shows the battery cell 1 which is arranged so as to be rotatably mounted about an axis of rotation 12. The axis of rotation 12 is oriented transversely to the gravitational direction. A distance between the opening 6 and the axis of rotation 12 is the shortest distance between the housing 2 and the axis of rotation 12. Preferably, the opening 6 extends in a surface of the housing 2 parallel to the axis of rotation 12, in particular, the axis of rotation 12 being in contact with the opening 6.

In a second method step of the method according to the invention, in a first rotation step, the battery cell 1 is rotated about the axis of rotation 12, in particular by multiple revolutions, in particular with a fixed frequency. In this case, a centrifugal force 13 acts on the electrolyte 7, which is oriented transversely to the axis of rotation 12. The centrifugal force 13 presses the electrolyte 7 in the housing 2 towards the base portion 10. Capillary forces 11 act transversely to the centrifugal force 13 from the wall of the housing 2 into the electrode arrangement 3. As a result, the first portion 4′ of the electrode arrangement 3 increases in size from the base portion 10 in the opposite direction to the centrifugal force 13. The second portion 4 of the electrode arrangement 3 decreases in size, a center of gravity of the second portion 4 being displaced towards the opening 6. Preferably, during the first rotation step, the battery cell 1 is unsealed.

Preferably, after the second method step, the battery cell 1 is reconnected to the valve 5 and filled with additional electrolyte 7.

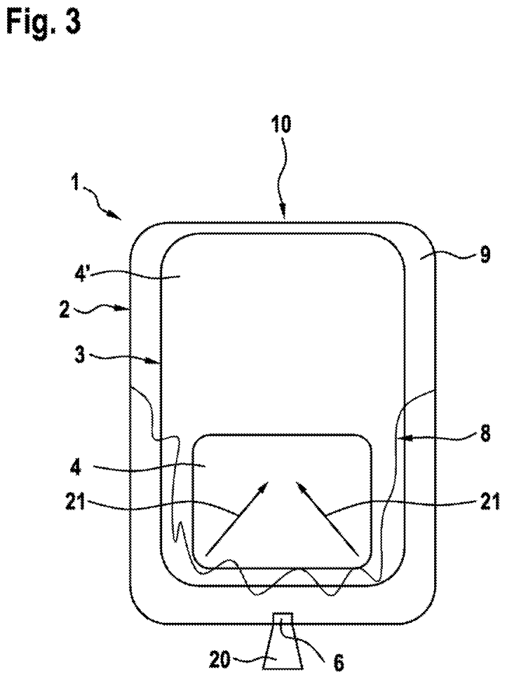

FIG. 3 shows the battery cell 1, the opening 6 of which has been sealed by a closure means 20, in particular a detachable closure means, preferably a plug or a metal strip, and which, in a third method step, in a second rotation step, is rotated by 160° to 200°, preferably 180°, in particular upside down, and subsequently mounted. After the second rotation step, the base portion 10 is the highest region of the housing in the gravitational direction. The gravitational force is thus oriented from the base portion 10 towards the opening 6. As a result, the electrolyte 7 flows towards the opening 6. Capillary forces 21 act against the gravitational force. The electrode arrangement 3 is wetted with electrolyte 7 from the opening 6 towards the base portion 10. The first portion 4′ of the electrode arrangement 3 thus increases in size.

Preferably, after the third method step, the closure means 20 is removed, and excess electrolyte 7 is released from the battery cell 1. Subsequently, the battery cell 1 is sealed, in particular by means of a pressure relief valve.

In another exemplary embodiment (not shown), the battery cell is pivotally connected to a shaft which is rotatable about the axis of rotation. The axis of rotation of the rotatable shaft is oriented parallel to the gravitational direction. During the first rotation step, the battery cell is deflected transversely to the gravitational direction by the centrifugal force.

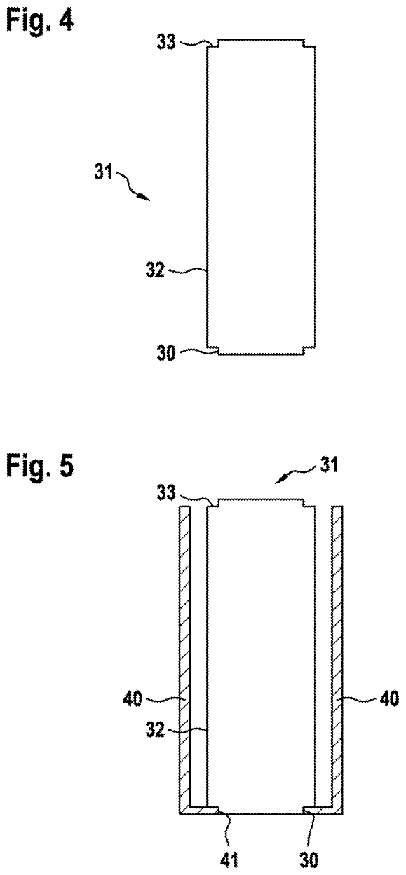

FIG. 4 shows a first exemplary embodiment of a battery cell 31 of a system according to the invention for producing a battery cell. The first exemplary embodiment of the battery cell 31 comprises a housing 32. The housing 32 has a substantially cylindrical or cuboid design and has at least one groove (30, 33) which is continuous in the peripheral direction. In this case, the groove (30, 33) is arranged on an end region of the housing 32. Preferably, the housing 32 has two grooves (30, 33) which are arranged on two mutually opposed end regions of the housing 32.

Preferably, each groove (30, 33) is in the form of a step in the housing 32. In this case, the diameter or a side length of the housing 32 tapers in a stepped manner towards the end of the housing 32.

FIG. 5 shows a first exemplary embodiment of a retaining means 40 of the system according to the invention for producing a battery cell. The retaining means 40 is in the form of a hollow cylinder or hollow cuboid and has a recess 41 on one lateral face. In this case, the recess 41 is advantageously dimensioned in such a way that the housing 32 of the battery cell 31 can be introduced into the recess 41 as far as the step of the groove (30, 33). The housing 32 can thus be connected to the retaining means 40 in an interlocking manner.

A lateral face of the retaining means 40 which is opposite the recess 41 is designed to be open. The battery cell 31 can be introduced into the retaining means 40 through this lateral face of the retaining means 40.

By the retaining means 40, the battery cell 31 can be connected to a rotatably mounted shaft of a rotating motor. In this case, the axis of rotation of the shaft is arranged at a distance from the center of gravity of the battery cell 31, in particular is arranged at a distance from the battery cell 31. Alternatively, the axis of rotation is in contact with a lateral face of the housing 32.

Advantageously, two or more battery cells 31 can be connected to the shaft, the axis of rotation being arranged between the battery cells 31 in a transverse direction to the axis of rotation.

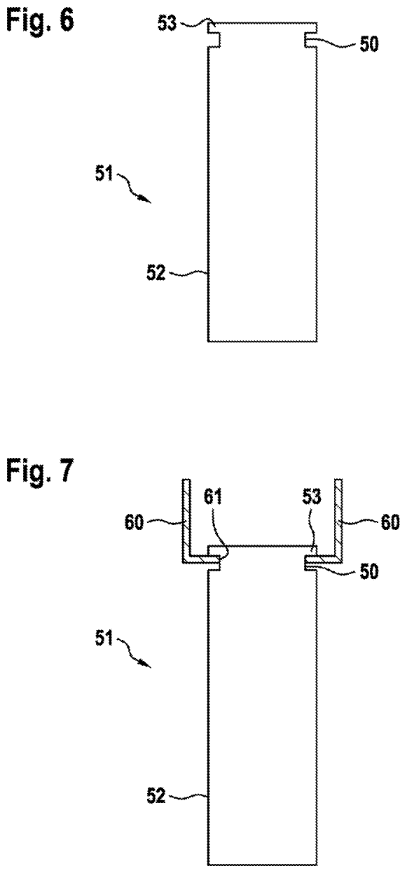

FIG. 6 shows a second exemplary embodiment of a battery cell 51 of a system according to the invention for producing a battery cell. The second exemplary embodiment of the battery cell 51 comprises a housing 52. The housing 52 has a substantially cylindrical or cuboid design and has a groove 50 which is continuous in the peripheral direction. In this case, the groove 50 is arranged on an end region of the housing 52. In this case, the groove 50 is arranged at a distance from a lateral face of the end region of the housing 52. The distance between the groove 50 and the lateral face is smaller than the smallest side length of the housing 52. A protrusion 53 is arranged between the groove 50 and the lateral face of the housing.

FIG. 7 shows a second exemplary embodiment of a retaining means 60 of the system according to the invention for producing a battery cell. The retaining means 60 is in the form of a hollow cylinder or hollow cuboid and has a recess 61 on one lateral face. In this case, the recess 61 is advantageously dimensioned in such a way that the housing 32 of the battery cell 51 can be introduced into the recess 61 by the groove 50. The housing 52 can thus be connected to the retaining means 60 in an interlocking manner.

Preferably, the retaining means 60 is designed to be elastically deformable, and therefore the housing 52 can be clipped into the retaining means 60. In this case, the retaining means 60 is elastically deformed so as to be guided over the protrusion 53 and then clips into the groove 50.

By the retaining means 60, the battery cell 51 can be connected to a rotatably mounted shaft of a rotating motor. In this case, the axis of rotation of the shaft is arranged at a distance from the center of gravity of the battery cell 51, in particular is arranged at a distance from the battery cell 51. Alternatively, the axis of rotation is in contact with a lateral face of the housing 52.

Advantageously, two or more battery cells 51 can be connected to the shaft, the axis of rotation being arranged between the battery cells 51 in a transverse direction to the axis of rotation.

1. A method for producing a battery cell (1), wherein the battery cell (1) has an electrode arrangement (3) and a housing (2) which has an opening (6), the method comprising the chronologically successive method steps:
filling the battery cell (1) with an electrolyte (7) via the opening, and
in a first rotation step, rotating the battery cell (1) about an axis of rotation (12).

2. The method as claimed in claim 1,
characterized in that
in a second rotation step, the battery cell (1), by contrast with the method step of filling with electrolyte, is rotated by 160° to 200°, and subsequently mounted.

3. The method as claimed in claim 2,
characterized in that
before the second rotation step, the opening (6) in the housing (2) is closed in a liquid-tight manner by a closure means (20).

4. The method as claimed in claim 3,
characterized in that
after the mounting, the closure means (20) is removed from the housing (2), and excess electrolyte (7) is released from the battery cell (1), in particular, the battery cell (1) subsequently

5. The method as claimed in claim 2,
characterized in that
before the second rotation step, additional electrolyte (7) is filled into the battery cell.

6. The method as claimed in claim 1,
characterized in that
in the first rotation step, the opening (6) is unsealed.

7. The method as claimed in claim 1,
characterized in that
during the filling of the battery cell (1), the electrolyte (7) flows from the opening (6) in the gravitational direction into the housing (2).

8. The method as claimed in claim 1,
characterized in that
the axis of rotation (12) is at a distance from the battery cell (1).

9. The method as claimed in claim 1,
characterized in that
a surface of the housing (2) having the opening (6) is at the shortest distance of the housing (2) from the axis of rotation (12).

10. The method as claimed in claim 11,
characterized in that
the surface is in contact with the axis of rotation (12) at least in part.

11. The method as claimed in claim 1,
characterized in that
the axis of rotation (12) is oriented transversely to the gravitational direction.

12. The method as claimed in claim 1,
characterized in that
during the first rotation step, the battery cell (1) is deflected in a transverse direction to the axis of rotation (12).

13. A system for producing a battery cell,
characterized in that
the system comprises a battery cell (31, 51) and a retaining means (40, 60), the battery cell being able to be connected by the retaining means (40, 60) to a rotatably mounted shaft of a rotating motor.

14. The system as claimed in claim 13,
characterized in that
the battery cell (31, 51) comprises a housing (32, 52) having a peripheral groove (30, 50),
the retaining means (40, 60) having a recess (41, 61),
the housing (32, 52) and the retaining means (40, 60) being able to be connected by means of the groove (30, 50)
and the recess (41, 61).

15. The system as claimed in claim 14,
characterized in that
the groove (30) has a stepped design,
the housing (32) tapering in a stepped manner towards one lateral face of the housing (32),
the retaining means (40) having a cavity in which at least part of the battery cell (31) is received.

16. The system as claimed in claim 15,
characterized in that
the recess (41) and the groove (30) have the same cross section.

17. The system as claimed in claim 14,
characterized in that
the housing (52) has a peripheral protrusion (53), the retaining means (60) being able to be clipped to the housing by means of the protrusion (53), the retaining means (60) being elastically deformable.

18. A system for producing a battery cell, the system being configured to perform the method as claimed in claim 1,
the system comprising a battery cell (31, 51) and a retaining means (40, 60), the retaining means (40, 60) being configured to connect the battery cell to a rotatably mounted shaft of a rotating motor.

19. The method as claimed in claim 1, wherein, in the first rotation step, the battery cell (1) is rotated about the axis of rotation (12) by more than 360°.

20. The method as claimed in claim 1,
characterized in that
in a second rotation step, the battery cell (1), by contrast with the method step of filling with electrolyte, is rotated by 180°, and subsequently mounted, the electrolyte (7) flowing in the gravitational direction to the opening (6).

21. The method as claimed in claim 2,
characterized in that
before the second rotation step, the opening (6) in the housing (2) is closed in a liquid-tight manner by a plug or a metal strip in a removable manner.

22. The method as claimed in claim 3,
characterized in that
after the mounting, the closure means (20) is removed from the housing (2), and excess electrolyte (7) is released from the battery cell (1), the battery cell (1) subsequently being sealed by means of a pressure relief valve.
